(19) United States
(12) Patent Application Publication
(10) Pub. No.: US 2024/0050848 A1
(43) Pub. Date: Feb. 15, 2024

(54) RE-RANKING RESULTS FROM SEMANTIC NATURAL LANGUAGE PROCESSING MACHINE LEARNING ALGORITHMS FOR IMPLEMENTATION IN VIDEO GAMES

(71) Applicant: GOOGLE LLC, Mountain View, CA (US)

(72) Inventors: Anna Kipnis, San Bruno, CA (US); Benjamin Pietrzak, San Francisco, CA (US)

(21) Appl. No.: 17/766,616

(22) PCT Filed: Apr. 30, 2020
(86) PCT No.: PCT/US2020/030646

§ 371 Date: Apr. 5, 2022

Related U.S. Application Data
(60) Provisional application No. 62/989,194, filed on Mar. 13, 2020.

(51) Int. Cl. A63F 13/424; G06F 40/30; A63F 13/422

(52) U.S. Cl. CPC A63F 13/424; G06F 40/30; A63F 13/422

(57) ABSTRACT

Program code representing a semantic natural language processing (NLP) machine learning (ML) algorithm is stored in a memory. A processor executes the semantic NLP ML algorithm to generate initial scores that represent a degree of matching between candidate responses and an input phrase provided by a user during execution of program code. The processor also modifies one or more of the initial scores using one or more rules that associate a first phrase with a second phrase. The one or more rules are selected to modify the initial scores based on semantic similarity of the user input phrase and the first phrase determined by the semantic NLP ML algorithm and the semantic similarity of the response phrase with a corresponding candidate response. Execution of the program code is modified based on the modified initial scores. In some cases, the semantic NLP ML algorithm is used to implement a video game.

### BACKGROUND

Machine learning (ML) techniques have not been widely adopted or implemented by video game developers, even though ML algorithms could be used to improve player experience in the game. One reason for the game developer's reluctance is that large corpuses of data are needed to train ML algorithms. For example, ML algorithms are well suited to implementing custom crafted examples such as key-framed animations, dialogue lines, or other content that is served to the player based on the current game context. However, training the ML algorithm would require building a corpus of training data by producing large numbers of custom-crafted examples, which is counterproductive due to the significant time and resource commitment needed to produce each example. Furthermore, games typically include finite storytelling and dialogue arcs that limit the “lifetime” of characters used in the game. Consequently, even if the game produced enough data to train an ML algorithm, the resulting trained model would not likely be useful because game developers would have moved on to different characters, stories, and worlds. The best-case scenario is that a game developer has access to a large corpus of training data for a game that is currently under development. However, even in that situation, training the ML algorithm requires significant resources such as expertise in machine learning and access to the machines, time, and budget needed to perform the computationally intensive training process, which are typically not available to game development teams.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system that supports re-ranking results from a semantic natural language processing (NLP) machine learning (ML) algorithm according to some embodiments.

FIG. 2 is a block diagram of a cloud-based system that supports re-ranking results from a semantic NLP ML algorithm according to some embodiments.

FIG. 3 is a block diagram of an instance of a semantic NLP ML algorithm that generates initial scores for responses to an input phrase according to some embodiments.

FIG. 4 is a block diagram illustrating a process of matching a rule to an input phrase and a set of candidate responses according to some embodiments.

FIG. 5 is a plot illustrating an input weight as a function of a corresponding first score according to some embodiments.

FIG. 6 is a plot illustrating a response weight as a function of a corresponding second score according to some embodiments.

FIG. 7 is a flow diagram of a method for re-ranking results returned by a semantic NLP ML algorithm for a single rule according to some embodiments.

FIG. 8 is a flow diagram of a method for re-ranking results returned by a semantic NLP ML algorithm for a set of rules according to some embodiments.

### DETAILED DESCRIPTION

Pre-trained machine learning (ML) algorithms that correspond to the relevant domain of a video game can be used to enhance player experience, such as through use of a semantic natural language processing (NLP) ML model. However, games frequently include idiosyncrasies that cause pre-trained ML algorithms to produce results that contradict the intentions of the game developers. For example, many game worlds purposely redefine concepts to contrast with their real-world interpretations such as using a raccoon suit to endow a character with the ability to fly, even though raccoons are typically unable to fly. An ML algorithm that is trained using real-world results will not understand the association between “raccoon suit” and “flight,” which will lead the ML algorithm to yield results that are inconsistent with the intentions of the game developers. Developers may also want to refine the results produced by the pre-trained ML algorithm to reflect the specific needs or goals of the game. For example, the developer may want to modify the results of the pre-trained ML algorithm to enhance the likelihood of particular results, relative to the outcomes produced by the pre-trained ML algorithm. Retraining the ML algorithm to produce these results would be computationally intensive (perhaps prohibitively so, as discussed above) and could lead to unexpected or undesired changes in the results produced by the ML algorithm in other contexts or in response to other inputs.

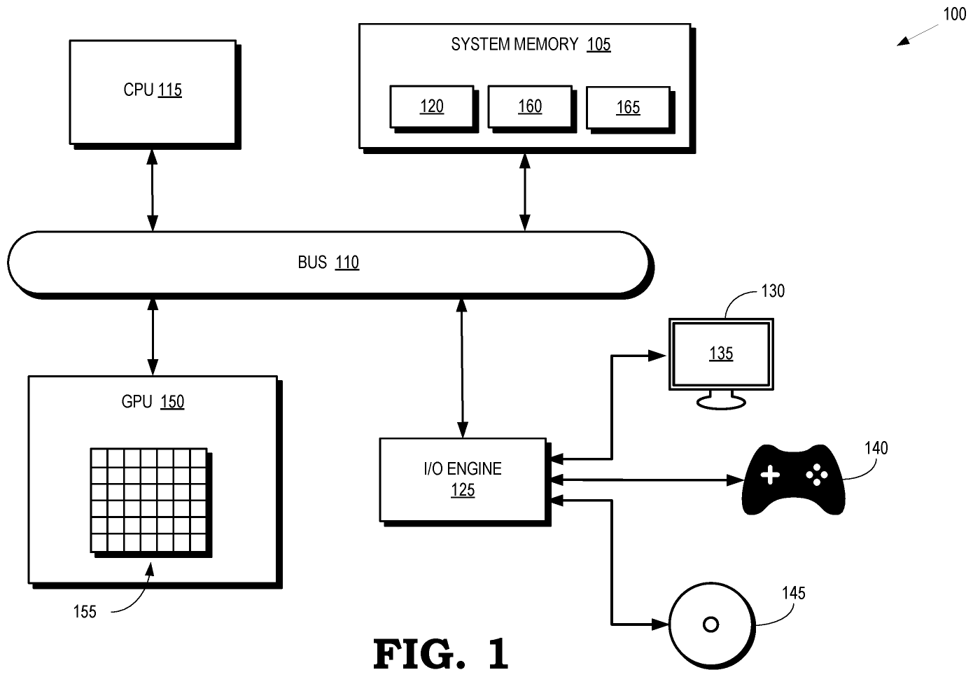

FIGS. 1-7 disclose systems and techniques for post-processing results produced by a pre-trained semantic NLP ML algorithm without retraining the semantic NLP ML algorithm. The post-processing is performed based on rules that associate a first phrase and a second phrase. Initially, a user input phrase and a set of candidate responses are provided to the semantic NLP ML algorithm, which generates an initial score that represents a degree of matching between the candidate responses and the user input phrase. For example, in a first modality, the semantic NLP ML algorithm provides a set of scores that indicate likelihoods that the candidate responses are an appropriate response to the user input phrase. For another example, in a second modality, the semantic NLP ML algorithm provides a set of scores that indicate likelihoods that the candidate responses are semantically similar to the user input phrase.

As used herein, the phrase “semantic similarity” refers to a metric defined over a set of documents or terms based on the likeness of their meaning or semantic content as opposed to similarity which can be estimated regarding their syntactical representation (e.g. their string format). A semantic similarity indicates a strength of the semantic relationship between units of language, concepts or instances, through a numerical description obtained according to the comparison of information supporting their meaning or describing their nature. Computationally, semantic similarity is estimated by defining a topological similarity, by using ontologies to define the distance between terms/concepts. For example, a metric for the comparison of concepts ordered in a partially ordered set and represented as nodes of a directed acyclic graph (e.g., a taxonomy), would be the shortest-path linking the two concept nodes. Based on text analyses, semantic relatedness between units of language (e.g., words, sentences) can also be estimated using statistical means such as a vector space model to correlate words and textual contexts from a suitable text corpus.

To determine whether a rule should be applied to the user input phrase, the semantic NLP ML algorithm generates a first score that represents the semantic similarity of the first phrase and the user input phrase. Some embodiments of the rule include an input threshold. In that case, the first score is converted to an input weight using a functional relationship between the input weight and the first score such as setting the input weight to zero for first scores below the input threshold and increasing the input weight linearly from zero to one for first scores ranging from the input threshold to a maximum score. The semantic NLP ML algorithm also generates a set of second scores that represent semantic similarities of the candidate responses to the second phrase. In some embodiments, the rule includes a response threshold that is used to convert the set of second scores to a corresponding set of response weights, as discussed above. The rule also includes a bias that determines the final scores for the candidate responses. In some embodiments, a total bias is equal to the product of the input weight, the response weight, and the bias. Thus, a total bias of zero is applied (i.e., the rule is not used to modify a candidate response) if the first score is less than the input threshold or the corresponding second score is less than the response threshold. If the rule is applied to a candidate response, the total bias is added to the initial score for the candidate response to generate a final score for the candidate response. The final scores for the candidate responses are then ranked.

Some embodiments of the rule-based postprocessing technique are used to implement semantic NLP ML algorithms in games. Rules are created by the game developer to modify the results generated by the semantic NLP ML algorithm without needing to retrain the semantic NLP ML algorithm. Input/response rules are used to influence player experience based on the game context, to choose non-player character responses to character statements or actions, to modify the association between phrases in a manner contrary to conventional usage of the phrases, and the like. In some embodiments, rules are added, modified, or removed from the game at runtime. For example, a rule can be defined based on a player's response to a game event such as adding an input/response rule to associate the circumstance “the door is locked” with the action “I press button” after the player presses a button near a locked door to unlock the door. For another example, the responses or behavior of non-player characters can be modified based on actions by the player that involve (or are observed by a) the non-player character. Implementing rule-based postprocessing therefore allows game developers to tailor or fine-tune the semantic NLP ML algorithm based on design considerations for their games without needing to modify or retrain the semantic NLP ML algorithm itself. Rule-based postprocessing of ML algorithms is also applicable in other contexts, such as responding to frequently-asked-questions (FAQs).

FIG. 1 is a block diagram of a processing system 100 that supports re-ranking results from a semantic natural language processing (NLP) machine learning (ML) algorithm according to some embodiments. The processing system 100 includes or has access to a memory 105 or other storage component that is implemented using a non-transitory computer readable medium such as a dynamic random-access memory (DRAM). However, some embodiments of the memory 105 are implemented using other types of memory including static RAM (SRAM), nonvolatile RAM, and the like. The processing system 100 also includes a bus 110 to support communication between entities implemented in the processing system 100, such as the memory 105. Some embodiments of the processing system 100 include other buses, bridges, switches, routers, and the like, which are not shown in FIG. 1 in the interest of clarity.

The processing system 100 includes a central processing unit (CPU) 115. Some embodiments of the CPU 115 include multiple processing elements (not shown in FIG. 1 in the interest of clarity) that execute instructions concurrently or in parallel. The processing elements are referred to as processor cores, compute units, or using other terms. The CPU 115 is connected to the bus 110 and the CPU 115 communicates with the memory 105 via the bus 110. The CPU 115 executes instructions such as program code 120 stored in the memory 105 and the CPU 115 stores information in the memory 105 such as the results of the executed instructions. The CPU 115 is also able to initiate graphics processing by issuing draw calls.

An input/output (I/O) engine 125 handles input or output operations associated with a display 130 that presents images or video on a screen 135. In the illustrated embodiment, the I/O engine 125 is connected to a game controller 140 which provides control signals to the I/O engine 125 in response to a user pressing one or more buttons on the game controller 140 or interacting with the game controller 140 in other ways, e.g., using motions that are detected by an accelerometer. The I/O engine 125 also provides signals to the game controller 140 to trigger responses in the game controller 140 such as vibrations, illuminating lights, and the like. In the illustrated embodiment, the I/O engine 125 reads information stored on an external storage component 145, which is implemented using a non-transitory computer readable medium such as a compact disk (CD), a digital video disc (DVD), and the like. The I/O engine 125 also writes information to the external storage component 145, such as the results of processing by the CPU 115. Some embodiments of the I/O engine 125 are coupled to other elements of the processing system 100 such as keyboards, mice, printers, external disks, and the like. The I/O engine 125 is coupled to the bus 110 so that the I/O engine 125 communicates with the memory 105, the CPU 115, or other entities that are connected to the bus 110.

The processing system 100 includes at least one graphics processing unit (GPU) 150 that renders images for presentation on the screen 135 of the display 130, e.g., by controlling pixels that make up the screen 135. For example, the GPU 150 renders visual content to produce values of pixels that are provided to the display 130, which uses the pixel values to display an image that represents the rendered visual content. The GPU 150 includes one or more processing elements such as an array 155 of compute units that execute instructions concurrently or in parallel. Some embodiments of the GPU 150 are used for general purpose computing. In the illustrated embodiment, the GPU 150 communicates with the memory 105 (and other entities that are connected to the bus 110) over the bus 110. However, some embodiments of the GPU 150 communicate with the memory 105 over a direct connection or via other buses, bridges, switches, routers, and the like. The GPU 150 executes instructions stored in the memory 105 and the GPU 150 stores information in the memory 105 such as the results of the executed instructions. For example, the memory 105 stores a copy 160 of instructions that represent a program code that is to be executed by the GPU 150.

The CPU 115, the GPU 150, or a combination thereof execute machine learning algorithms such as a semantic NLP ML algorithm. In the illustrated embodiment, the memory 105 stores a program code that represents a semantic NLP ML algorithm 165 that has been trained using a corpus of natural language data. Many text corpuses are available for training machine learning algorithms including corpuses related to media/product reviews, news articles, email/spam/newsgroup messages, tweets, dialogues, and the like. The CPU 115, and/or the GPU 150 (or one or more of the compute units in the array 155) executes the program code that represents the trained semantic NLP ML algorithm 165 in either input/response modality or a semantic similarity modality to generate scores that represent a degree of matching between candidate responses and an input phrase. The results generated by applying the semantic NLP ML algorithm are modified based on a set of rules, as discussed herein. In some embodiments, the semantic NLP ML algorithm 165 generates initial scores for a set of candidate responses to an input phrase based on comparisons of the candidate responses to the input phrase. The semantic NLP ML algorithm 165 then modifies one or more of the initial scores using a rule that associates a first phrase with a second phrase. The rule is selected to modify one or more of the initial scores based on semantic similarity of the user input phrase and the first phrase determined by the semantic NLP ML algorithm 165 and a semantic similarity of the candidate phrases with the second phrase, as discussed below. The CPU 115, and/or the GPU 150 (or one or more of the compute units in the array 155) modifies execution of the program code based on the modified initial scores.

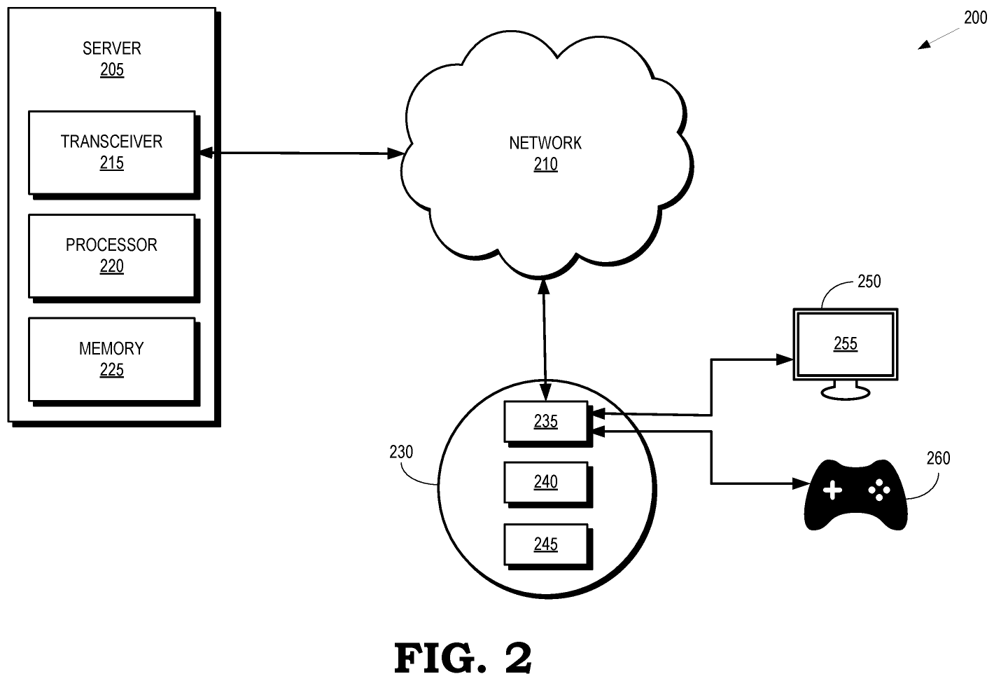

FIG. 2 is a block diagram of a cloud-based system 200 that supports re-ranking results from a semantic NLP ML algorithm according to some embodiments. The cloud-based system 200 includes a server 205 that is interconnected with a network 210. Although a single server 205 shown in FIG. 2, some embodiments of the cloud-based system 200 include more than one server connected to the network 210. In the illustrated embodiment, the server 205 includes a transceiver 215 that transmits signals towards the network 210 and receives signals from the network 210. The transceiver 215 can be implemented using one or more separate transmitters and receivers. The server 205 also includes one or more processors 220 and one or more memories 225. The processor 220 executes instructions such as program code stored in the memory 225 and the processor 220 stores information in the memory 225 such as the results of the executed instructions.

The cloud-based system 200 includes one or more processing devices 230 such as a computer, set-top box, gaming console, and the like that are connected to the server 205 via the network 210. In the illustrated embodiment, the processing device 230 includes a transceiver 235 that transmits signals towards the network 210 and receives signals from the network 210. The transceiver 235 can be implemented using one or more separate transmitters and receivers. The processing device 230 also includes one or more processors 240 and one or more memories 245. The processor 240 executes instructions such as program code stored in the memory 245 and the processor 240 stores information in the memory 245 such as the results of the executed instructions. The transceiver 235 is connected to a display 250 that displays images or video on a screen 255 and a game controller 260. Some embodiments of the cloud-based system 200 are therefore used by cloud-based game streaming applications.

The processor 220, the processor 240, or a combination thereof execute program code representative of a semantic NLP ML algorithm in either input/response modality or a semantic similarity modality. As discussed herein, the semantic NLP ML algorithm is pre-trained using one or more text corpuses. The results generated by applying the semantic NLP ML algorithm are modified based on a set of rules, as discussed herein.

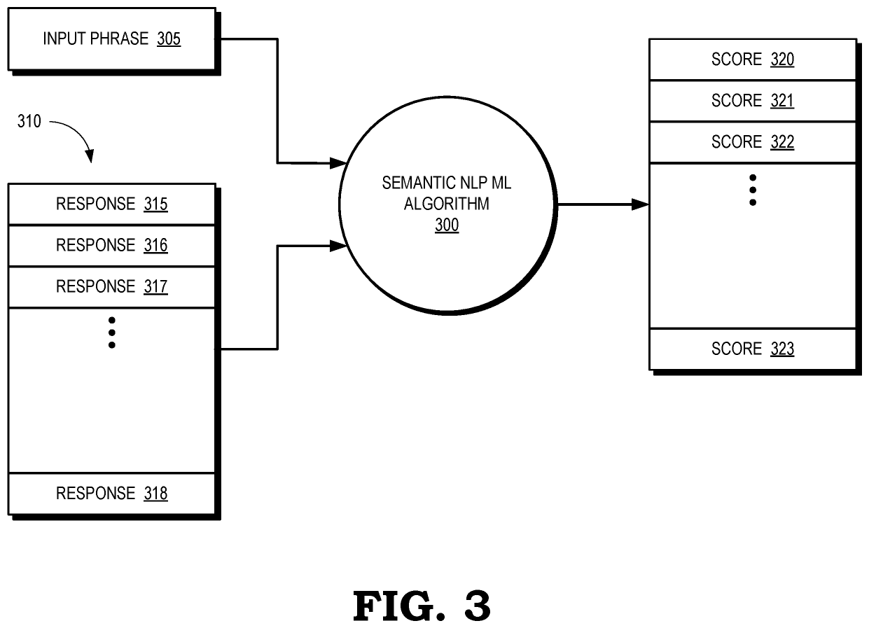

FIG. 3 is a block diagram of an instance of a semantic NLP ML algorithm 300 that generates initial scores for responses to an input phrase 305 according to some embodiments. The semantic NLP ML algorithm 300 is instantiated by some embodiments of the CPU 115 and the GPU 150 shown in FIG. 1 and the processors 220, 240 shown in FIG. 2. As discussed herein, the semantic NLP ML algorithm 300 is pre-trained using one or more text corpuses. The input phrase 305 is provided to the semantic NLP ML algorithm 300, e.g., in response to a user providing the phrase in a form that is converted to text such as typing, cutting-and-pasting, using speech recognition software, using optical character recognition software, and the like. A set 310 of responses 315, 316, 317, 318 (collectively referred to herein as “the responses 315-318”) is also provided to the semantic NLP ML algorithm 300. The set 310 is predetermined by a developer, dynamically generated by program code such as that used to implement a game, or selected/generated using other techniques.

In the illustrated embodiment, the semantic NLP ML algorithm 300 operates in the input/response modality and therefore generates scores 320, 321, 322, 323 (collectively referred to herein as “the scores 320-323”) that indicate how well each of the responses 315-318 serves as an appropriate response to the input phrase 305. For example, the semantic NLP ML algorithm 300 can compare an input phrase 305 of “I say hello” to the response 315 of “I wave,” the response 316 of “I buy a car,” the response 317 of “The dog barks,” and the response 318 of “The sun goes down.” In that case, the semantic NLP ML algorithm 305 returns a relatively high score 320 (e.g., a score close to 1.0) for the response 315 and relatively low scores 321-323 for the responses 316-318. Some embodiments of the semantic NLP ML algorithm 300 rank the responses 315-318 based on the scores 320-323.

Pre-training the semantic NLP ML algorithm 300 on conventional text corpuses causes the semantic NLP ML algorithm 300 to generate higher scores 320-323 for responses that are consistent with conventional usage or interpretation of the terms in the input phrase 305 and the responses 315-318. However, some embodiments of the semantic NLP ML algorithm 300 are implemented in other contexts that rely on unconventional usage or interpretations of some phrases. For example, as discussed herein, many game worlds purposely redefine concepts to contrast with their real-world interpretations. Post-processing of the results provided by the semantic NLP ML algorithm 300 is therefore used to modify the initial scores 320-323 based on one or more rules that redefine the associations between the input phrase 305 and the responses 315-318.

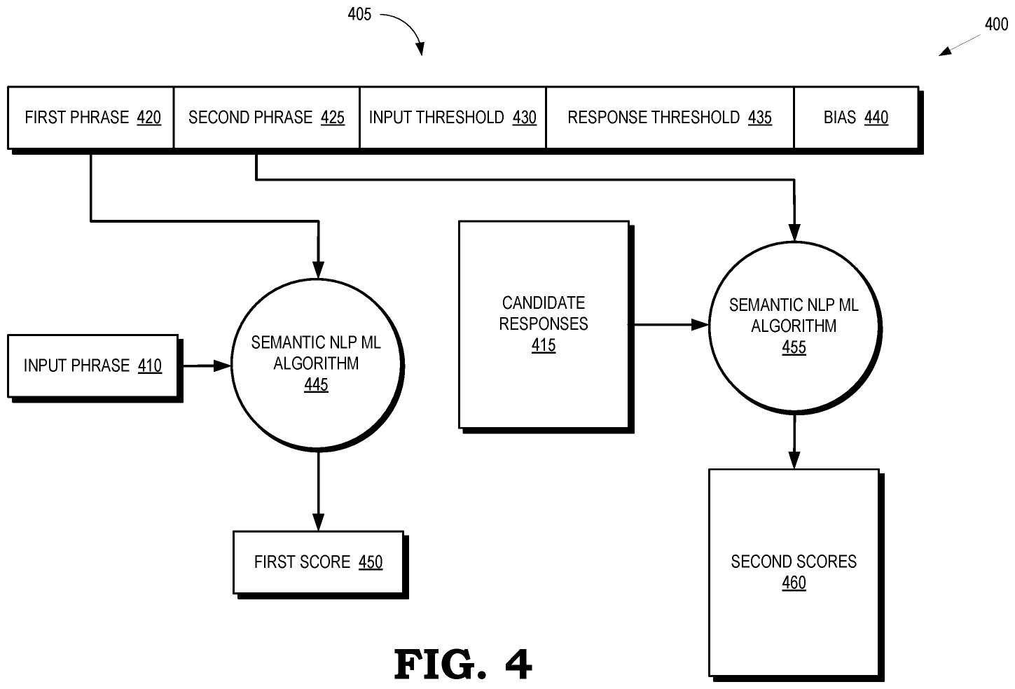

FIG. 4 is a block diagram illustrating a process 400 of matching a rule 405 to an input phrase 410 and a set 415 of candidate responses according to some embodiments. The rule 405 is used to modify some embodiments of the initial scores 320-323 shown in FIG. 3. In the illustrated embodiment, the rule 405 includes a first phrase 420 that is compared to the input phrase 410, a second phrase 425 that is compared to each of the candidate responses in the set 415, an input threshold 430 that sets a minimum score for applying the rule 405 to the input phrase 410, a response threshold 435 that sets a minimum score for applying the rule 405 to the response, and a bias 440 that is used to modify the initial scores. The semantic NLP ML algorithm used by the process 400 are pre-trained on conventional text corpuses, as discussed herein.

A first instance of the semantic NLP ML algorithm 445 operates in a semantic similarity modality to generate a first score 450 that represents the semantic similarity of the input phrase 410 to the first phrase 420. For example, the first score 450 returned by the semantic NLP ML algorithm 445 is relatively high if the input phrase 410 is “I say hi” and the first phrase 420 in the rule 405 is “I say hello.” A second instance of the semantic NLP ML algorithm 455 also operates in the semantic similarity modality to generate a set 460 of second scores that indicate the semantic similarities of the candidate responses in the set 415 to the second phrase 425. For example, a second score returned by the semantic NLP ML algorithm 455 is relatively high for a candidate response of “I fist bump” if the second phrase 425 is “I celebrate.”

The first score 450 and the second scores in the set 460 are compared to corresponding first and second thresholds, e.g., the input threshold 430 and the response threshold 435, respectively. The rule 405 is applied to an association between the input phrase 410 and a candidate response in the set 415 if the first score 450 and second score in the set 460 exceed their corresponding thresholds. If the threshold criteria are satisfied, first and second weights are determined for the input phrase and the candidate response in the set 415. In some embodiments, the semantic matching score returned by the semantic NLP ML algorithms 445, 455 ranges from a score of 0.0 for a complete mismatch between the input phrase 410 and the first phrase 420 (or a complete mismatch between a candidate response in the set 415 and the second phrase 425) to a score of 1.0 for a perfect match between the input phrase 410 and the first phrase 420 (or a perfect match between a candidate response in the set 415 and the second phrase 425). In that case, the first and second weights range from 0.0 when a score is equal to the threshold and 1.0 when the score is 1.0 for a perfect match.

Some embodiments of the relationship between the first score 450 and the first threshold and the relationship between the second scores in the set 460 and second thresholds are determined using linear functions. For example, the relationship between the first score 450 and the first weight can be given by the formula:

$$First Weight = \frac{First Score - First Threshold}{1 - First Theshold} ; \\ First Score > First Threshold \\ First Weight = 0. ; First Score \leq First Threshold$$

The relationship between the second score (from the set 460) and the second weight can be given by the formula:

$$Second Weight = \frac{Second Score - Second Threshold}{1 - Second Theshold} ; \\ Second Score > Second Threshold \\ Second Weight = 0. ; Second Score \leq Second Threshold$$

However, other relationships such as non-linear relationships between the scores and the weights are implemented in some embodiments.

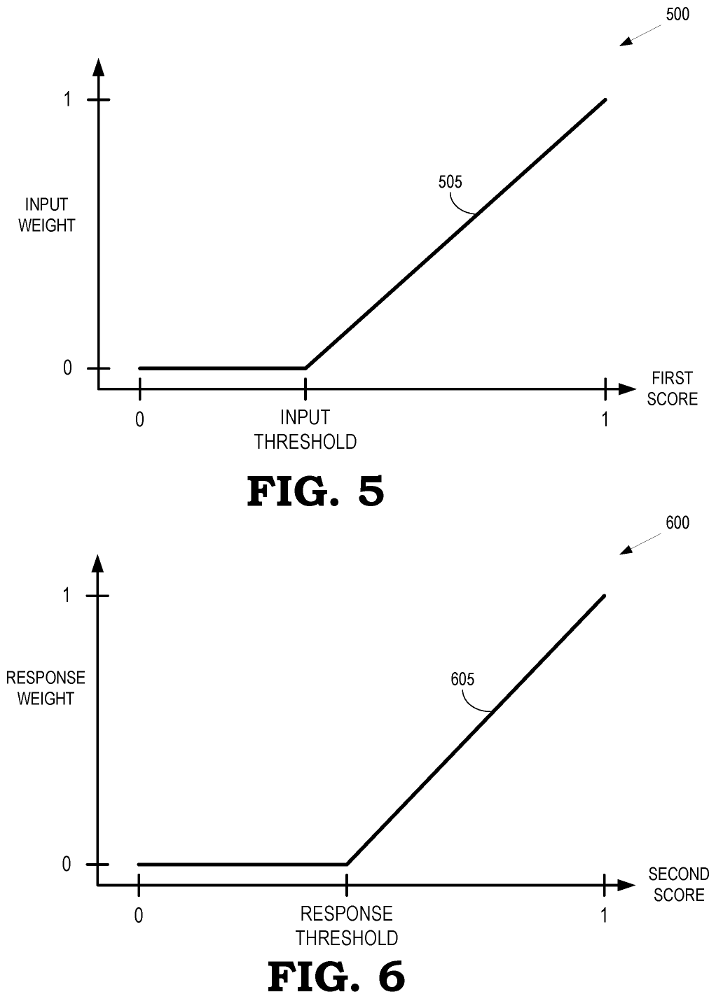

FIG. 5 is a plot 500 illustrating an input weight 505 as a function of a corresponding first score according to some embodiments. The vertical axis indicates the input weight ranging from zero to one and the horizontal axis indicate the first score in the range from zero to one. For values of the first score below or equal to the input threshold, the input weight 505 is equal to zero and then the input weight 505 rises linearly from zero to one as the first score increases from the input threshold to the maximum score of one.

FIG. 6 is a plot 600 illustrating a response weight 605 as a function of a corresponding second score according to some embodiments. The vertical axis indicates the response weight ranging from zero to one and the horizontal axis indicate the second score in the range from zero to one. For values of the second score below or equal to the input threshold, the response weight 605 is equal to zero and then the response weight 605 rises linearly from zero to one as the second score increases from the response threshold to the maximum score of one.

Table 1 shows a set of rules that are defined by input phrases (referred to as “If This” phrases), response phrases (referred to as “Then This” phrases) and corresponding thresholds and biases.

TABLE 1

| | Then This | If This | Then This | Total |
|---|---|---|---|---|
| If This (Input) | (Response) | Threshold | Threshold | Bias |
| I hit you | I cry | 0.6 | 0.6 | 40 |
| I throw ball to you | I cheer | 0.5 | 0.5 | 40 |
| I say stop following me | I follow you | 0.6 | 0.6 | −10 |
| I say follow me | I follow you | 0.6 | 0.6 | 10 |
| Hi | I get very very | 0.6 | 0.6 | 40 |
| | sad | | | |

As discussed above, a rule is applied to modify the initial scores generated by a semantic NLP ML algorithm if the input and response phrases are semantically similar to the first and second phrases that are defined in the rule, e.g., the semantic similarity scores generated by the semantic NLP ML algorithm exceeded corresponding thresholds. In that case, a total bias is calculated based on the weights and the bias defined in the rule, such as the bias 440 shown in FIG. 4. In some embodiments, the total bias is defined as the product of the input weight, the response weight, and the bias indicated in the rule.

Table 2 shows a set of rules that are defined by input phrases (referred to as “If This” phrases), response phrases (referred to as “Then This” phrases) and corresponding biases. The rules shown in Table 2 associate the same input and response phrases but use an alternate, streamlined representation of the bias. For example, the responses can be biased as very unlikely, kind of unlikely, kind of likely, and very likely.

TABLE 2

| If the input is . . . | Then bias the response . . . | To be . . . |
|---|---|---|
| I hit you | I cry | Very unlikely |
| I throw ball to you | I cheer | Very likely |
| I say stop following me | I follow you | Kind of unlikely |
| I say follow me | I follow you | Kind of likely |
| Hi | I get very sad | Very likely |

Although the rules discussed herein are in the format of input/response rules, some embodiments of the techniques disclosed herein also include implementations of rules in other formats that do not necessarily use a one-way association, e.g., arbitrary associations between different phrases or commutative rules. The final bias for the candidate responses can also be treated as scores, which is useful for tracking and creating/boosting a signal for information inside large bodies of data such as a game log at a late stage of a play through of a complex game. Semantic phrases can therefore be tracked through the text log and arbitrarily re-associated with different semantic meanings.

Some embodiments of the rules are added, modified, or removed at runtime. If agents are implemented using artificial intelligence (AI) based on the semantic NLP ML algorithm, their behavior in a game world or the content of the game world are changed by adding, modifying, or removing one or more rules in response to a triggering event that occurs during a play through of the game. For example, if the semantic NLP ML algorithm is used to determine (at least in part) behavior of an agent in the game, the agent can be associated with a triggering event such as opening a door to a room. In that case, the steps associated with performing an action are used to define the phrases associated by a rule. For example, if a player in a game approaches a closed door and tries to perform the action “I open the door,” a status update indicates that “the door is locked.” The player then presses a nearby button, which causes the door to open. The system therefore determines the rule that associates the input phrase “I attempt to open a locked door” with the response “I press button.” Corresponding thresholds and biases are also defined for the rule. Rules are also defined by having players demonstrate an action in response to a stimulus. Teachable actions that can be expressed in natural language can therefore be learned using one or more examples to “teach” agents using Association rules.

In some embodiments, rule-based associations are generated based on interactions between players and agents, or between agents, so that the behavior of the agent evolves in response to interactions that occur during the game. For example, an agent can learn by mimicking the behavior of a player. If a player points to a book and says, “this is the most interesting thing in the room.” A rule is created to associate “book” with “the most interesting thing in the room.” Once the agent has learned this rule, the agent responds to a request to identify “the most interesting thing in the room” by pointing to the “book.” The behavior of the agents is therefore dependent upon the events or actions that occur during the game and (at least in part) on the choices made by the player or the personality of the player. Rules, either predetermined or dynamically determined, are used to define some embodiments of the characters or agents in the game, e.g., by defining their moods, personalities, archetypal behaviors, and the like. Different characters are given different personalities by associating the same inputs with different responses.

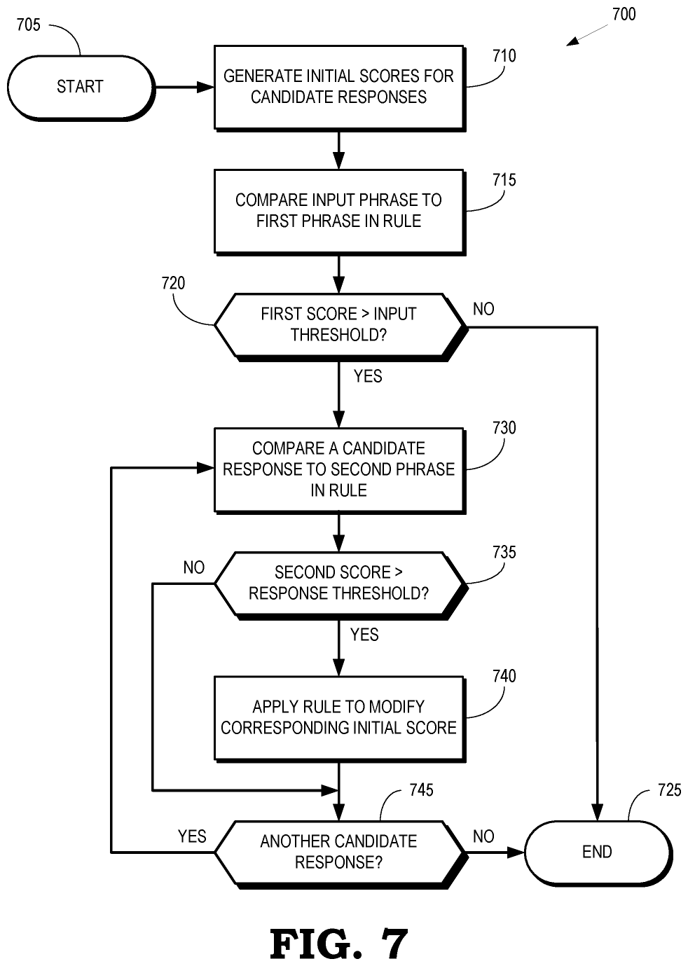

FIG. 7 is a flow diagram of a method 700 for re-ranking results returned by a semantic NLP ML algorithm for a single rule according to some embodiments. The method 700 is implemented in a processor that executes one or more instances of the semantic NLP ML algorithm such as some embodiments of the CPU 115 and the GPU 150 shown in FIG. 1 and the processors 220, 240 shown in FIG. 2.

The method 700 starts at block 705. At block 710, the semantic NLP ML algorithm generates initial scores for a set of candidate responses by comparing the candidate responses to an input phrase. The semantic NLP ML algorithm is operating in the input/response modality in block 710.

At block 715, the semantic NLP ML algorithm compares the input phrase to a first phrase in a rule. The semantic NLP ML algorithm is operating in the semantic similarity modality in block 715 and therefore returns a score indicating the semantic similarity of the input phrase and the first phrase in the rule.

At decision block 720, the processor determines whether the first score exceeds the input threshold defined by the rule. If the first score is less than the input threshold, the method 700 flows to the block 725 and the method 700 ends without the rule being applied to modify the initial scores generated by the semantic NLP ML algorithm. If the score is greater than the input threshold, the method 700 flows to the block 730.

At block 730, the semantic NLP ML algorithm compares one of the candidate responses to the second phrase in the rule. The semantic NLP ML algorithm returns a score indicating the semantic similarity of the candidate response and the second phrase.

At decision block 735, the processor determines whether the second score exceeds the response threshold defined by the rule. If the second score is greater than the input threshold, the method 700 flows to the block 740. If the second score is less than or equal to the input threshold, the method 700 flows to the decision block 745.

At block 740, the rule is applied to modify the corresponding initial score. In some embodiments, applying the rule includes calculating an input weight and a response weight. A total bias is then calculated based on the input weight, the response weight, and a bias indicated in the rule. The total bias is added to the initial score to determine the final modified score.

At block 745, the processor determines whether there is another candidate response in the set of candidate responses. If so, the method 700 flows to the block 730 and another candidate response is considered. If not, the method 700 flows to block 725 and the method 700 ends.

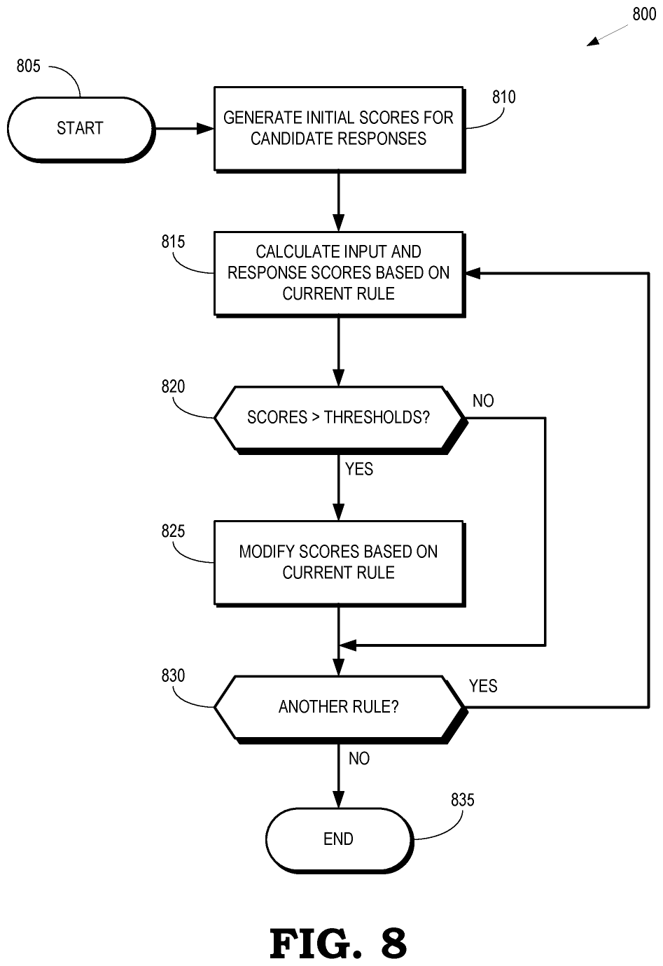

FIG. 8 is a flow diagram of a method 800 for re-ranking results returned by a semantic NLP ML algorithm for a set of rules according to some embodiments. The method 800 is implemented in a processor that executes one or more instances of the semantic NLP ML algorithm such as some embodiments of the CPU 115 and the GPU 150 shown in FIG. 1 and the processors 220, 240 shown in FIG. 2.

The method 800 starts at block 805. At block 810, the semantic NLP ML algorithm generates initial scores for a set of candidate responses by comparing the candidate responses to an input phrase. The semantic NLP ML algorithm is operating in the input/response modality in block 810.

At block 815, the semantic NLP ML algorithm calculates input and response scores using a current rule being considered by the method 800 at the current iteration. In some embodiments, the method 800 calculates the input and response scores as discussed above, e.g., with regard to FIG. 7. The semantic NLP ML algorithm is operating in the semantic similarity modality in block 815 and therefore returns scores indicating the semantic similarity of the input phrase and the first phrase in the current rule and indicating the semantic similarity of the response phrase and the second phrase in the current rule.

At decision block 820, the method 800 determines whether the input and response scores are greater than the corresponding thresholds. If so, the method 800 flows to block 825. If not, the method 800 flows to decision block 830.

At block 825, the scores are modified based on the current rule. In some embodiments, modifying the scores includes determining a bias based on the current rule and adding the bias to the scores, as discussed herein. The modifications produced by rules in the set of rules considered by the method 800 are cumulative and so re-ranking based on each of the rules “stacks” with the re-ranking based on the other rules in the set. The method 800 then flows to block 830.

At block 830, the method 800 determines whether there are additional rules in the set to consider. If so, the method 800 flows to block 810 and a new rule from the set is considered as the current rule. If not, the method 800 flows to block 835 and the method 800 ends.

In some embodiments, certain aspects of the techniques described above are implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc , magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

In the following some embodiment are described as examples.

Example 1: A method comprising:
generating, using a semantic natural language processing (NLP) machine learning (ML) algorithm, initial scores that represent a degree of matching between a set of candidate responses and an input phrase provided by a user during execution of program code;
modifying at least one of the initial scores using at least one rule that associates a first phrase with a second phrase, wherein the at least one rule is selected to modify the at least one of the initial scores based on semantic similarity of the input phrase and the first phrase determined by the semantic NLP ML algorithm and the semantic similarity of the response phrase with a corresponding candidate response; and
modifying execution of the program code based on the at least one modified initial score.

Example 2: The method of example 1, wherein modifying the at least one of the initial scores comprises generating, using the semantic NLP ML algorithm, a first score that represents semantic similarity of the first phrase and the input phrase.

Example 3: The method of example 1 or 2, wherein modifying the at least one of the initial scores comprises generating, using the semantic NLP ML algorithm, second scores that represent semantic similarities of the set of candidate responses and the second phrase.

Example 4: The method of at least one of the preceding examples, wherein the at least one rule indicates an input threshold for the first phrase and a response threshold for the second phrase, wherein modifying the at least one of the initial scores comprises converting the first score to an input weight using a first functional relationship between the first score and the input threshold, and wherein modifying the at least one of the initial scores comprises converting the second scores to response weights using a second functional relationship between the second scores and the response threshold.

Example 5: The method of example 4, wherein the first functional relationship sets the input weight to zero in response to the first score being below the input threshold and increases the input weight linearly from zero to one in response to the first score being above the input threshold and below a maximum score, and wherein the second functional relationship sets each of the response weights to zero in response to the corresponding second score being below the response threshold and increases each of the response weights linearly from zero to one in response to the corresponding second score being above the response threshold and below a maximum score.

Example 6: The method of at least one of the preceding examples, wherein the at least one rule specifies a bias, and wherein a total bias for each of the candidate responses is equal to a product of the input weight, the corresponding response weight, and the bias specified by the rule.

Example 7: The method of example 6, wherein the at least one rule is not used to modify each of the candidate responses that have a total bias of zero due to at least one of the first score being below the input threshold and the corresponding second score being below the response threshold.

Example 8: The method of example 6 or 7, wherein modifying the at least one of the initial scores comprises adding the total bias to the initial scores for the set of candidate responses to generate final scores for the set of candidate responses based on the at least one rule.

Example 9: The method of example 8, further comprising:
ranking the set of candidate responses based on the final scores.

Example 10: The method of example 9, further comprising:
applying the ranked set of candidate responses to influence player experience during execution of a video game.

Example 11: The method of at least one of the preceding examples, further comprising at least one of:
adding an additional rule to the game at runtime; modifying the at least one rule or the additional rule in the game at runtime; and
removing the at least one rule or the additional rule from the game at runtime.

Example 12: An apparatus, comprising:
a memory configured to store a program code representative of a semantic natural language processing (NLP) machine learning (ML) algorithm; and
a processor configured to execute the semantic NLP ML algorithm to generate initial scores that represent a degree of matching between a set of candidate responses and an input phrase provided by a user during execution of the program code and modify at least one of the initial scores using at least one rule that associates a first phrase with a second phrase, wherein the at least one rule is selected to modify the at least one of the initial scores based on semantic similarity of the input phrase and the first phrase determined by the semantic NLP ML algorithm and the semantic similarity of the response phrase with a corresponding candidate response, and wherein the processor is configured to modify execution of the program code based on the at least one modified initial score.

Example 13: The apparatus of example 12, wherein the processor is configured to generate, by executing the semantic NLP ML algorithm, a first score that represents semantic similarity of the first phrase and the input phrase.

Example 14: The apparatus of example 12 or 13, wherein the processor is configured to generate, by executing the semantic NLP ML algorithm, second scores that represent semantic similarities of the set of candidate responses and the second phrase.

Example 15: The apparatus of at least one of the examples 12 to 14, wherein the rule indicates an input threshold for the first phrase and a response threshold for the second phrase, wherein the processor is configured to convert the first score to an input weight using a first functional relationship between the first score and the input threshold, and wherein the processor is configured to convert the second scores to response weights using a second functional relationship between the second scores and the response threshold.

Example 16: The apparatus of example 15, wherein the first functional relationship sets the input weight to zero in response to the first score being below the input threshold and increases the input weight linearly from zero to one in response to the first score being above the input threshold and below a maximum score, and wherein the second functional relationship sets each of the response weights to zero in response to the corresponding second score being below the response threshold and increases each of the response weights linearly from zero to one in response to the corresponding second score being above the response threshold and below a maximum score.

Example 17: The apparatus of example 15 or 16, wherein the at least one rule specifies a bias, and wherein a total bias for each of the candidate responses is equal to a product of the input weight, the corresponding response weight, and the bias specified by the rule.

Example 18: The apparatus of at least one of the examples 15 to 17, wherein the at least one rule is not used to modify each of the candidate responses that have a total bias of zero due to at least one of the first score being below the input threshold and the corresponding second score being below the response threshold.

Example 19: The apparatus of at least one of the examples 15 to 18, wherein the processor is configured to add the total bias to the initial scores for the set of candidate responses to generate final scores for the set of candidate responses.

Example 20: The apparatus of example 19, wherein the processor is configured to rank the set of candidate responses based on the final scores.

Example 21: The apparatus of example 20, wherein the processor is configured to apply the ranked set of candidate responses to influence player experience in a game, or to choose non-player character responses to character statements or actions in the game, or to modify an association between the first phrase and the second phrase in a manner contrary to conventional usage of the first phrase or the second phrase.

Example 22: The apparatus of example 21, wherein the processor is configured to perform at least one of:
adding an additional rule to the game at runtime;
modifying the at least one rule or the additional rule in the game at runtime; and
removing the at least one rule or the additional rule from the game at runtime.

Example 23: A non-transitory computer readable medium embodying a set of executable instructions, the set of executable instructions to manipulate at least one processor to perform the method of any of examples 1 to 10.

Example 24: A system to perform the method of any of examples 1 to 10.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A method comprising:
generating, using a semantic natural language processing (NLP) machine learning (ML) algorithm, initial scores that represent a degree of matching between a set of candidate responses and an input phrase provided by a user during execution of program code;
modifying at least one of the initial scores using at least one rule that associates a first phrase with a second phrase, wherein the at least one rule is selected to modify the at least one of the initial scores based on semantic similarity of the input phrase and the first phrase determined by the semantic NLP ML algorithm and the semantic similarity of the response phrase with a corresponding candidate response; and
modifying execution of the program code based on the at least one modified initial score.

2. The method of claim 1, wherein modifying the at least one of the initial scores comprises generating, using the semantic NLP ML algorithm, a first score that represents semantic similarity of the first phrase and the input phrase.

3. The method of claim 1, wherein modifying the at least one of the initial scores comprises generating, using the semantic NLP ML algorithm, second scores that represent semantic similarities of the set of candidate responses and the second phrase.

4. The method of claim 1, wherein the at least one rule indicates an input threshold for the first phrase and a response threshold for the second phrase, wherein modifying the at least one of the initial scores comprises converting the first score to an input weight using a first functional relationship between the first score and the input threshold, and wherein modifying the at least one of the initial scores comprises converting the second scores to response weights using a second functional relationship between the second scores and the response threshold.

5. The method of claim 4, wherein the first functional relationship sets the input weight to zero in response to the first score being below the input threshold and increases the input weight linearly from zero to one in response to the first score being above the input threshold and below a maximum score, and wherein the second functional relationship sets each of the response weights to zero in response to the corresponding second score being below the response threshold and increases each of the response weights linearly from zero to one in response to the corresponding second score being above the response threshold and below a maximum score.

6. The method of claim 4, wherein the at least one rule specifies a bias, and wherein a total bias for each of the candidate responses is equal to a product of the input weight, the corresponding response weight, and the bias specified by the rule.

7. The method of claim 6, wherein the at least one rule is not used to modify each of the candidate responses that have a total bias of zero due to at least one of the first score being below the input threshold and the corresponding second score being below the response threshold.

8. The method of claim 6, wherein modifying the at least one of the initial scores comprises adding the total bias to the initial scores for the set of candidate responses to generate final scores for the set of candidate responses based on the at least one rule.

9. The method of claim 8, further comprising:
ranking the set of candidate responses based on the final scores.

10. The method of claim 9, further comprising:
applying the ranked set of candidate responses to influence player experience during execution of a video game.

11. The method of claim 10, further comprising at least one of:
adding an additional rule to the video game at runtime;
modifying the at least one rule or the additional rule in the video game at runtime; and
removing the at least one rule or the additional rule from the video game at runtime.

12. An apparatus, comprising:
a memory configured to store a program code representative of a semantic natural language processing (NLP) machine learning (ML) algorithm; and
a processor configured to execute the semantic NLP ML algorithm to generate initial scores that represent a degree of matching between a set of candidate responses and an input phrase provided by a user during execution of the program code and modify at least one of the initial scores using at least one rule that associates a first phrase with a second phrase, wherein the at least one rule is selected to modify the at least one of the initial scores based on semantic similarity of the input phrase and the first phrase determined by the semantic NLP ML algorithm and the semantic similarity of the response phrase with a corresponding candidate response, and wherein the processor is configured to modify execution of the program code based on the at least one modified initial score.

13. The apparatus of claim 12, wherein the processor is configured to generate, by executing the semantic NLP ML algorithm, a first score that represents semantic similarity of the first phrase and the input phrase.

14. The apparatus of claim 12, wherein the processor is configured to generate, by executing the semantic NLP ML algorithm, second scores that represent semantic similarities of the set of candidate responses and the second phrase.

15. The apparatus of claim 12, wherein the rule indicates an input threshold for the first phrase and a response threshold for the second phrase, wherein the processor is configured to convert the first score to an input weight using a first functional relationship between the first score and the input threshold, and wherein the processor is configured to convert the second scores to response weights using a second functional relationship between the second scores and the response threshold.

16. The apparatus of claim 15, wherein the first functional relationship sets the input weight to zero in response to the first score being below the input threshold and increases the input weight linearly from zero to one in response to the first score being above the input threshold and below a maximum score, and wherein the second functional relationship sets each of the response weights to zero in response to the corresponding second score being below the response threshold and increases each of the response weights linearly from zero to one in response to the corresponding second score being above the response threshold and below a maximum score.

17. The apparatus of claim 15, wherein the at least one rule specifies a bias, and wherein a total bias for each of the candidate responses is equal to a product of the input weight, the corresponding response weight, and the bias specified by the rule.

18. The apparatus of claim 15, wherein the at least one rule is not used to modify each of the candidate responses that have a total bias of zero due to at least one of the first score being below the input threshold and the corresponding second score being below the response threshold.

19. The apparatus of claim 18, wherein the processor is configured to add the total bias to the initial scores for the set of candidate responses to generate final scores for the set of candidate responses.

20. The apparatus of claim 19, wherein the processor is configured to rank the set of candidate responses based on the final scores.

21. The apparatus of claim 20, wherein the processor is configured to apply the ranked set of candidate responses to influence player experience in a game, or to choose non-player character responses to character statements or actions in the game, or to modify an association between the first phrase and the second phrase in a manner contrary to conventional usage of the first phrase or the second phrase.

22. The apparatus of claim 21, wherein the processor is configured to perform at least one of:
adding an additional rule to the game at runtime;
modifying the at least one rule or the additional rule in the game at runtime; and
removing the at least one rule or the additional rule from the game at runtime.

23. A non-transitory computer readable medium embodying a set of executable instructions, the set of executable instructions to manipulate at least one processor to perform the method of claim 1.

24. (canceled)
